(19) United States
(12) Patent Application Publication
(10) Pub. No.: US 2013/0205261 A1
(43) Pub. Date: Aug. 8, 2013

(54) USER INTERFACE APPARATUS

(71) Applicant: Sanyo Electric Co., Ltd., Moriguchi-shi (JP)

(72) Inventor: Akira TOBA, Osaka-shi (JP)

(73) Assignee: Sanyo Electric Co., Ltd., Moriguchi-shi (JP)

(21) Appl. No.: 13/760,515

(22) Filed: Feb. 6, 2013

(30) Foreign Application Priority Data
Feb. 6, 2012 (JP) 2012-022663

(51) Int. Cl. G06F 3/0482

(52) U.S. Cl. CPC G06F 3/0482
USPC 715/835

(57) ABSTRACT

A user interface apparatus includes a first displayer. A first displayer displays any one of a plurality of images on a monitor screen. A first updater updates an image to be displayed by the first displayer according to a first rule when a first touch operation to the monitor screen is detected. A second displayer displays a specific icon on the monitor screen when an updating manner by the first updater satisfies a predetermined condition. A second updater updates the image to be displayed by the first displayer according to a second rule when a second touch operation to the specific icon displayed by the second displayer is detected.

### CROSS REFERENCE OF RELATED APPLICATION

The disclosure of Japanese Patent Application No. 2012-22663, which was filed on Feb. 6, 2012, is incorporated herein by reference.

### BACKGROUND OF THE INVENTION

1. Field of the Invention

The present invention relates to a user interface apparatus, and in particular, relates to a user interface apparatus which updates a display of a monitor screen in response to a touch operation to the monitor screen.

2. Description of the Related Art

According to one example of this type of apparatus, a touch panel which detects a contact point is arranged above a display surface of a display portion which displays a plurality of icons. Moreover, a plurality of touch effective ranges are respectively set to the plurality of icons. If the detected contact point exists within any one of the touch effective ranges, a process according to a corresponding icon is executed. In contrary, if the detected contact point deviates from any touch effective ranges, a display format of the icon is changed so as to reduce a mistake in selecting the icon.

However, in the above-described apparatus, touch operations of a plurality of manners such as a flick operation and a tap operation are not assumed, and therefore, an operability is limited.

### SUMMARY OF THE INVENTION

A user interface apparatus according to the present invention comprises: a first displayer which displays any one of a plurality of images on a monitor screen; a first updater which updates an image to be displayed by the first displayer according to a first rule when a first touch operation to the monitor screen is detected; a second displayer which displays a specific icon on the monitor screen when an updating manner by the first updater satisfies a predetermined condition; and a second updater which updates the image to be displayed by the first displayer according to a second rule when a second touch operation to the specific icon displayed by the second displayer is detected.

According to the present invention, an update control program recorded on a non-transitory recording medium in order to control a user interface apparatus, the program causing a processor of the user interface apparatus to perform the steps comprises: a first displaying step of displaying any one of a plurality of images on a monitor screen; a first updating step of updating an image to be displayed by the first displaying step according to a first rule when a first touch operation to the monitor screen is detected; a second displaying step of displaying a specific icon on the monitor screen when an updating manner by the first updating step satisfies a predetermined condition; and a second updating step of updating the image to be displayed by the first displaying step according to a second rule when a second touch operation to the specific icon displayed by the second displaying step is detected.

According to the present invention, an update control method executed by a user interface apparatus, comprises: a first displaying step of displaying any one of a plurality of images on a monitor screen; a first updating step of updating an image to be displayed by the first displaying step according to a first rule when a first touch operation to the monitor screen is detected; a second displaying step of displaying a specific icon on the monitor screen when an updating manner by the first updating step satisfies a predetermined condition; and a second updating step of updating the image to be displayed by the first displaying step according to a second rule when a second touch operation to the specific icon displayed by the second displaying step is detected.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a photographed image displayed on an LCD monitor;

FIG. 4 is an illustrative view showing one example of a transition behavior of the photographed image displayed on the LCD monitor;

FIG. 5(A) is an illustrative view showing one example of a state where a right-jump icon is overlapped on the photographed image;

FIG. 5(B) is an illustrative view showing one example of a state where a left-jump icon is overlapped on the photographed image;

FIG. 6 is a flowchart showing one portion of behavior of a CPU applied to the embodiment in FIG. 2;

FIG. 7 is a flowchart showing another portion of behavior of the CPU applied to the embodiment in FIG. 2;

FIG. 8 is a flowchart showing still another portion of behavior of the CPU applied to the embodiment in FIG. 2; and

FIG. 9 is a block diagram showing a configuration of another embodiment of the present invention.

### DETAILED DESCRIPTION OF THE PREFERRED EMBODIMENTS

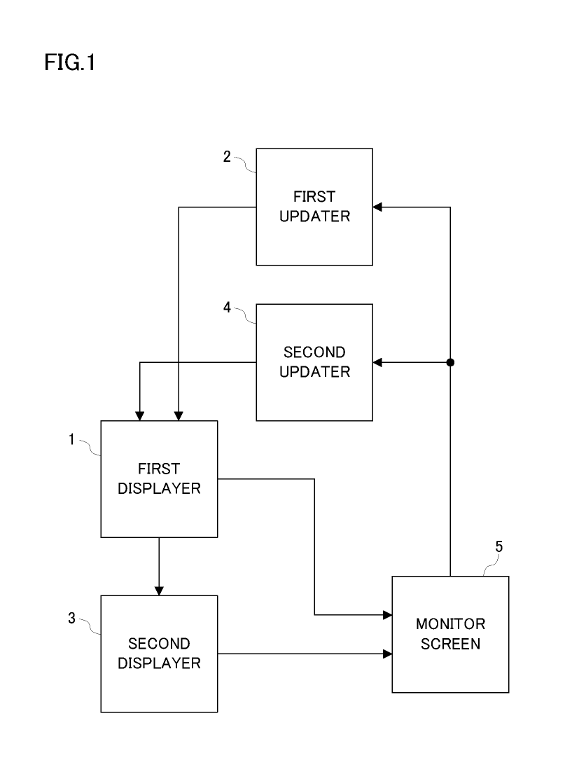

With reference to FIG. 1, a user interface apparatus according to one embodiment of the present invention is basically configured as follows: A first displayer 1 displays any one of a plurality of images on a monitor screen 5. A first updater 2 updates an image to be displayed by the first displayer 1 according to a first rule when a first touch operation to the monitor screen 5 is detected. A second displayer 3 displays a specific icon on the monitor screen 5 when an updating manner by the first updater 2 satisfies a predetermined condition. A second updater 4 updates the image to be displayed by the first displayer 1 according to a second rule when a second touch operation to the specific icon displayed by the second displayer 3 is detected.

Where the image to be displayed on the monitor screen 5 is updated according to the first rule when the first touch operation to the monitor screen 5 is detected, the specific icon is displayed on the monitor screen 5 when the updating manner satisfies the predetermined condition. When the second touch operation to the displayed specific icon is detected, the image to be displayed on the monitor screen 5 is updated according to the second rule. Thereby, an operability is improved.

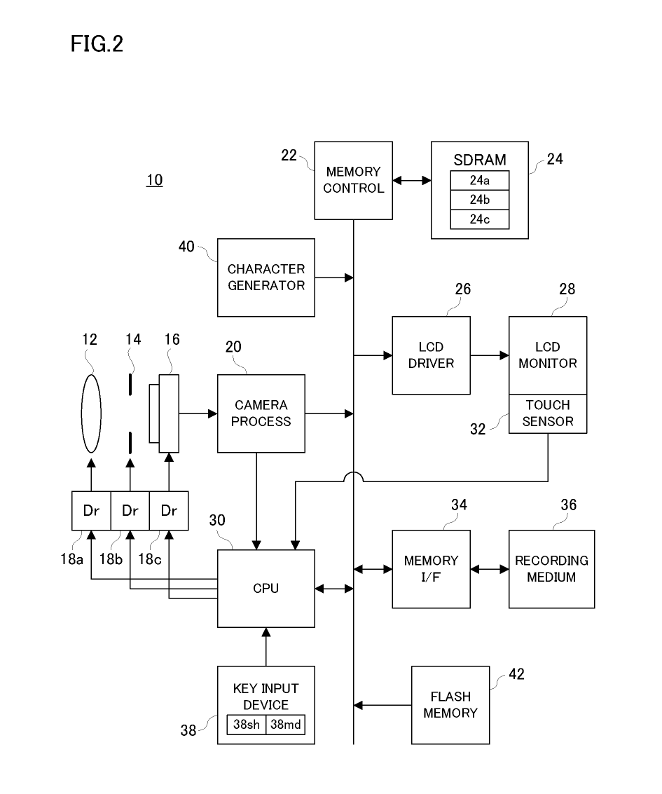

With reference to FIG. 2, a digital camera 10 according to one embodiment includes a focus lens 12 and an aperture unit 14 driven by drivers 18a and 18b, respectively. An optical image that underwent the focus lens 12 and the aperture unit 14 enters, with irradiation, an imaging surface of an imaging device 16, and is subjected to a photoelectric conversion. Thereby, electric charges representing a scene captured on the imaging surface are produced.

When a camera mode is selected by a mode selector switch 38md arranged in a key input device 38, in order to execute a moving-image taking process, a CPU 30 commands a driver 18c to repeat an exposure procedure and an electric-charge reading-out procedure, and commands an LCD driver 26 to display a moving image.

In response to a vertical synchronization signal Vsync outputted from an SG (Signal Generator) not shown, the driver 18c exposes the imaging surface and reads out the electric charges produced on the imaging surface in a raster scanning manner. From the imaging device 16, raw image data that is based on the read-out electric charges is cyclically outputted.

A camera processing circuit 20 performs processes, such as white balance adjustment, color separation, and YUV conversion, on the raw image data outputted from the imaging device 16, and writes YUV formatted-image data created thereby, into a moving-image area 24a of an SDRAM 24 through a memory control circuit 22. The LCD driver 26 reads out the image data stored in the moving-image area 24a through the memory control circuit 22, and drives an LCD monitor 28 based on the read-out image data. As a result, a real-time moving image (a live view image) representing the scene captured on the imaging surface is displayed on a monitor screen.

When a shutter button 38sh arranged in the key input device 38 is in a non-operated state, the CPU 30 executes a simple AE process in order to calculate an appropriate EV value based on the image data created by the camera processing circuit 20. An aperture amount and an exposure time period that define the calculated appropriate EV value are set to the drivers 18b and 18c, respectively. As a result, a brightness of a live view image displayed on the LCD monitor 28 is adjusted approximately.

When the shutter button 38sh is half-depressed, in order to calculate an optimal EV value based on the image data created by the camera processing circuit 20, the CPU 30 executes a strict AE process. Similarly as described above, an aperture amount and an exposure time period that define the calculated optimal EV value are set to the drivers 18b and 18c, respectively. Thereby, the brightness of the live view image displayed on the LCD monitor 28 is adjusted strictly.

Subsequently, the CPU 30 executes an AF process with reference to a high-frequency component of the image data created by the camera processing circuit 20. The focus lens 12 is moved in an optical-axis direction, and is placed at a focal point thereafter. Thereby, a sharpness of the live view image displayed on the LCD monitor 28 is improved.

When the shutter button 38sh is fully depressed, the CPU 30 personally executes a still-image taking process and commands a memory I/F 34 to execute a recording process. Image data representing a scene at a time point when the shutter button 38sh is operated is evacuated from the moving-image area 24a to a still image area 24b as photographed image data. The memory I/F 34 commanded to execute the recording process reads out the evacuated photographed image data through the memory control circuit 22, and records the read-out photographed image data on a recording medium 36 in a file format

When a reproducing mode is selected by the mode selector switch 38md, the CPU 30 executes following processes under a reproducing task

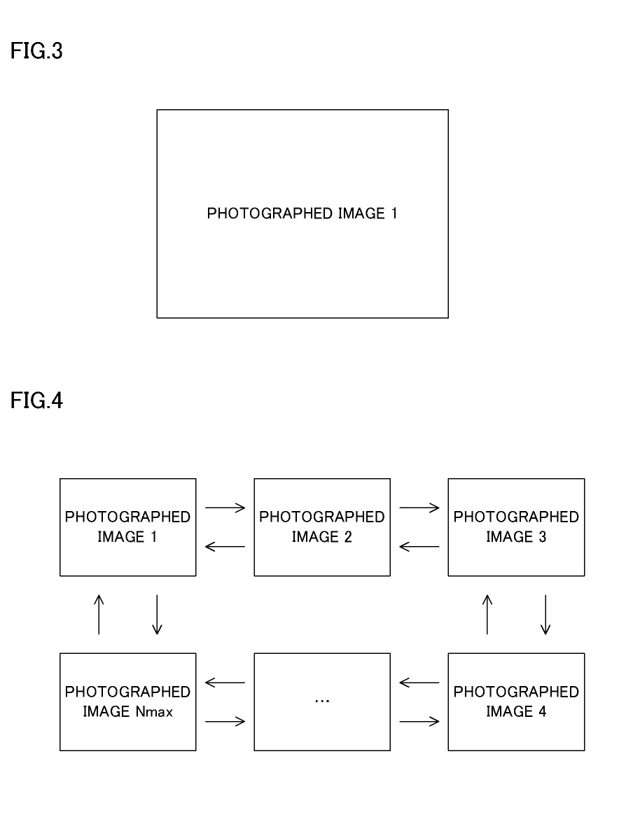

Firstly, the CPU 30 designates an image file of the latest frame as a reproduced file from among a plurality of image files recorded in the recording medium 36, and commands the memory I/F 34 and the LCD driver 26 to execute reproducing the file. The memory I/F 34 reads out photographed image data contained in the image file of the latest frame from the recording medium 36 so as to write the read-out photographed image data into the still-image area 24b of the SDRAM 24 through the memory control circuit 22. The LCD driver 26 reads out the photographed image data thus written through the memory control circuit 22 so as to drive the LCD monitor 28 based on the read-out photographed image data. As a result, the photographed image is displayed on the monitor screen as shown in FIG. 3.

When the touch operation is performed to the monitor screen, it is detected by a touch sensor 32 which position on the monitor screen is touched and which of “left flick”, “right flick” and “tap” is a manner of the touch operation. Detection information in which a touch position and an operation manner are described is outputted from the touch sensor 32.

When detection information in which an operation manner indicating the “right flick” is described is applied from the touch sensor 32, the CPU 30 designates an image file of a previous frame as the reproduced file. On the other hand, when detection information in which an operation manner indicating the “left flick” is described is applied from the touch sensor 32, the CPU 30 designates an image file of a succeeding frame as the reproduced file. The designated image file is subjected to the reproducing process similarly as described above. As a result, the photographed image displayed on the LCD monitor 28 is updated to a photographed image of a previous frame or a succeeding frame.

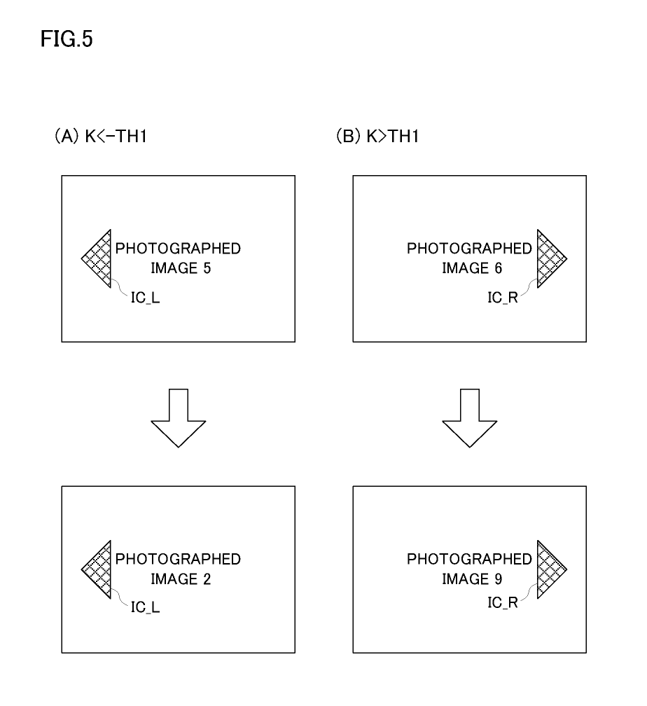

Thus, when the plurality of image files or photographed images recorded in the recording medium 36 are lined up as shown in FIG. 4, a photographed image to be displayed is updated to a clockwise direction at every time a left flick operation is detected, and is updated to an anticlockwise direction at every time a right flick operation is detected.

The CPU 30 decrements a variable K at every time the right flick operation is detected, and increments the variable K at every time the left flick operation is detected. However, the variable K is set to “−1” or “1” when a direction of this flick operation is a direction opposite to a direction of a previous flick operation. That is, when a direction of the flick operation reverses from left to right, the variable K is set to “−1”, whereas when the direction of the flick operation reverses from right to left, the variable K is set to “1”.

When a value of the variable K thus updated falls below a threshold value “−TH1”, the CPU 30 commands the character generator 40 and the LCD driver 26 to display a left-jump icon IC_L. In contrary, when the value of the variable K exceeds a threshold value “TH1”, the CPU 30 commands the character generator 40 and the LCD driver 26 to display a right-jump icon IC_R. It is noted that “TH1” is “5”, for example.

The character generator 40 creates left-jump icon data or right-jump icon data so as to write the created jump icon data into a character image area 24c of the SDRAM 24 through the memory control circuit 22. The LCD driver 26 reads out the jump icon data thus stored in the character image area 24c, through the memory control circuit 22, so as to drive the LCD monitor 28 based on the read-out jump icon data. As a result, the left-jump icon IC_L or the right-jump icon IC_R is overlapped on the photographed image as shown in FIG. 5(A) or FIG. 5(B).

When detection information in which an operation manner indicating the “tap” and a position of the left-jump icon IC_L are described is applied from the touch sensor 32 in a state where the left-jump icon IC_L is displayed on the monitor screen, the CPU 30 designates a three frames prior image file as the reproduced file. In contrary, when detection information in which the operation manner indicating the “tap” and a position of the right-jump icon IC_R are described is applied from the touch sensor 32 in a state where the right-jump icon IC_R is displayed on the monitor screen, the CPU 30 designates a three frames later image file as the reproduced file.

The designated image file is subjected to the reproducing process similarly as described above. As a result, the photographed image displayed on the LCD monitor 28 is updated to a three frames prior photographed image or a three frames later photographed image (see FIG. 5(A) or FIG. 5(B)).

Moreover, when the direction of the flick operation reverses, the CPU 30 commands the LCD driver 26 to hide a currently displayed jump icon. The LCD driver 26 suspends reading out the jump icon data from the character image area 24c, and as a result, the currently displayed jump icon disappears from the monitor screen.

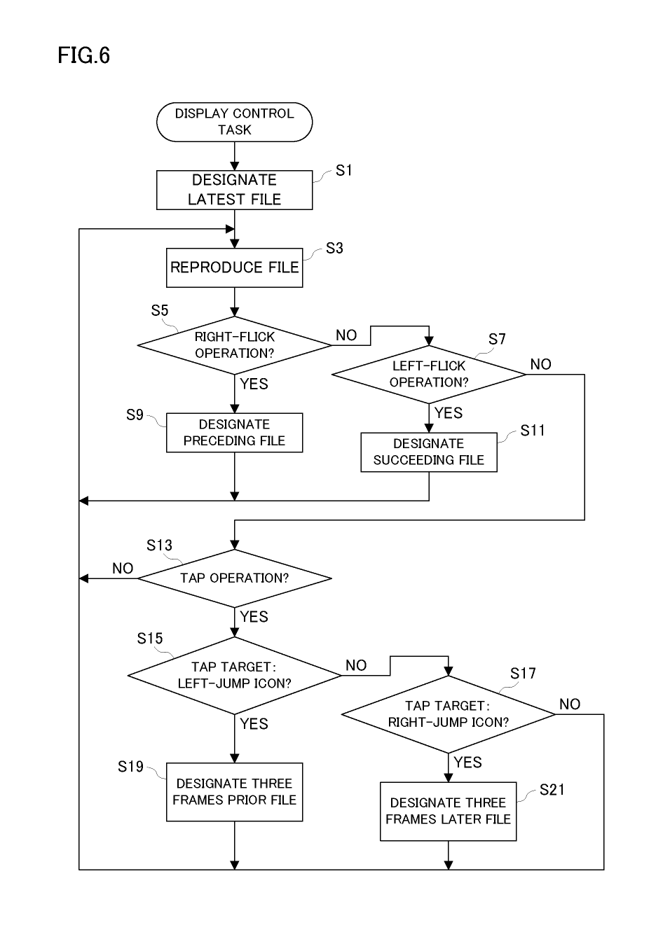

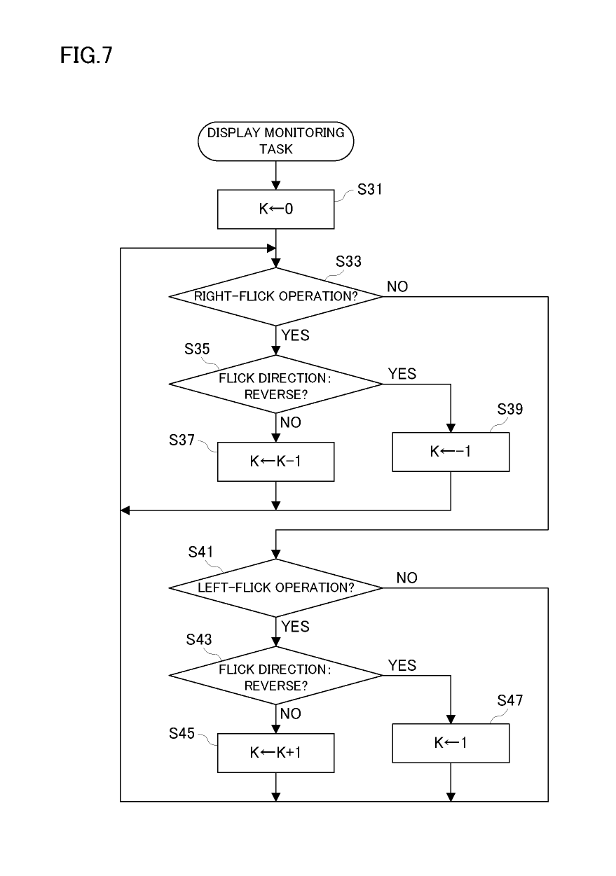

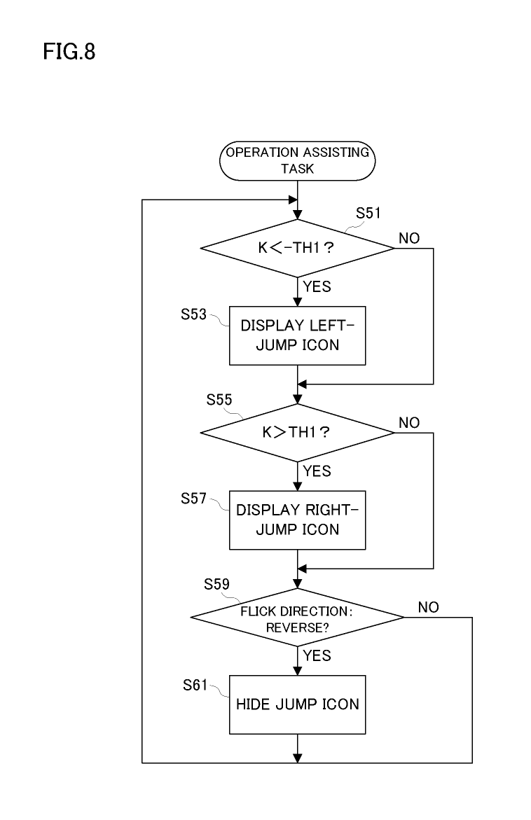

When the reproducing mode is selected, the CPU 30 executes, under a control of the multi task operating system, a plurality of tasks including a display control task shown in FIG. 6, a display monitoring task shown in FIG. 7 and an operation assisting task shown in FIG. 8, in a parallel manner. It is noted that control programs corresponding to these tasks are stored in a flash memory 42.

With reference to FIG. 6, in a step S1, an image file of the latest frame is designated as a reproduced file, and in a step S3, the memory I/F 34 and the LCD driver 26 are commanded to execute reproducing the file. The memory I/F 34 reads out photographed image data contained in the latest image file from the recording medium 36 so as to write the read-out photographed image data into the still-image area 24b of the SDRAM 24 through the memory control circuit 22. The LCD driver 26 reads out the photographed image data thus written from the SDRAM 24 through the memory control circuit 22 so as to drive the LCD monitor 28 based on the read-out photographed image data. As a result, the photographed image is displayed on the monitor screen.

In the step S3, it is determined whether or not the right flick operation to the monitor screen is performed, and in a step S7, it is determined whether or not the left flick operation to the monitor screen is performed. In a step S13, it is determined whether or not the tap operation to the monitor screen is performed. These determining processes are executed with reference to a description of the detection information applied from the touch sensor 32.

When a determined result of a step S5 is YES, the process advances to a step S9 so as to designate an image file of a previous frame as a reproduced file. On the other hand, when a determined result of the step S7 is YES, the process advances to a step S11 so as to designate an image file of a succeeding frame as the reproduced file. Upon completion of the process in the step S9 or S11, the process returns to the step S3. As a result, the photographed image displayed on the LCD monitor 28 is updated to a photographed image of a previous frame or a succeeding frame.

When a determined result of the step S13 is YES, in a step S15, it is determined whether or not a target of the tap operation is the left-jump icon IC_L, and in a step S17, it is determined whether or not the target of the tap operation is the right-jump icon IC_R. These determining processes are executed with reference to an attribute of a displayed image at a current time point and a description of the detection information applied from the touch sensor 32.

When a determined result of the step S15 is YES, the process advances to a step S19 so as to designate a three frames prior image file as the reproduced file. On the other hand, when a determined result of the step S17 is YES, the process advances to a step S21 so as to designate a three frames later image file as the reproduced image. Upon completion of the process in the step S19 or S21, the process returns to the step S3.

With reference to FIG. 7, in a step S31, the variable K is set to “0”. In a step S33, it is determined whether or not the right flick operation is performed, and in a step S41, it is determined whether or not the left flick operation is performed. These determining processes are also executed with reference to the description of the detection information applied from the touch sensor 32.

When a determined result of the step S33 is YES, the process advances to a step S35 so as to determine whether or not a direction of the flick operation has reversed. When a determined result is NO, the variable K is decremented in a step S37 whereas when the determined result is YES, the variable K is set to “−1” in a step S39. Upon completion of the step S37 or S39, the process returns to the step S33.

When a determined result of the step S41 is YES, a process similar to the step S35 is executed in a step S43. When a determined result is NO, the variable K is incremented in a step S45 whereas when the determined result is YES, the variable K is set to “1” in a step S47. Upon completion of the process in the step S45 or S47, the process returns to the step S33.

With reference to FIG. 8, in a step S51, it is determined whether or not the variable K falls below the threshold value “−TH1”, and in a step S55, it is determined whether or not the variable K exceeds the threshold value “TH1”. In a step S59, it is determined whether or not the direction of the flick operation has reversed.

When a determined result of the step S51 is YES, the process advances to a step S53 so as to command the character generator 40 and the LCD driver 26 to display the left-jump icon IC_L. In contrary, when a determined result of the step S55 is YES, the process advances to a step S57 so as to command the character generator 40 and the LCD driver 26 to display the right-jump icon IC_R.

The character generator 40 creates left-jump icon data or right-jump icon data so as to write the created jump icon data into the character image area 24c of the SDRAM 24 through the memory control circuit 22. The LCD driver 26 reads out the jump icon data thus stored in the character image area 24c, through the memory control circuit 22, so as to drive the LCD monitor 28 based on the read-out jump icon data. As a result, the left-jump icon IC_L or the right-jump icon IC_R is displayed on the LCD monitor 28 in an OSD manner.

When a determined result of the step S59 is YES, the process advances to a step S61 so as to command the LCD driver 26 to hide a currently displayed jump icon. The LCD driver 26 suspends reading out the jump icon data from the character image area 24c, and as a result, the currently displayed jump icon disappears from the monitor screen. Moreover, regarding the step S53, S57 or S61, the twice consecutive process does not make sense.

As can be seen from the above-described explanation, when the flick operation to the LCD monitor 28 in which the photographed image is displayed is detected by the touch sensor 32, the CPU 30 updates the photographed image to be displayed on the LCD monitor 28 by one frame (=according to the first rule) (S5 to S11). When five consecutive flick operations to the same direction is detected, the CPU 30 regards that the update manner of the photographed image satisfies the predetermined condition, and displays the jump icon on the LCD monitor 28 (S33 to S37, S41 to S45, S51 to S57). When the tap operation to the displayed jump icon is detected by the touch sensor 32, the CPU 30 updates the photographed image to be displayed on the LCD monitor 28 by three frames (=according to the second rule) (S13 to S21).

The photographed image to be displayed on the LCD monitor 28 is updated by one frame when the flick operation to the monitor screen is detected whereas the jump icon is displayed on the monitor screen when the update manner satisfies the predetermined condition. When the tap operation to the displayed jump icon is detected, the photographed image to be displayed on the LCD monitor 28 is updated by three frames. Thereby, the operability is improved.

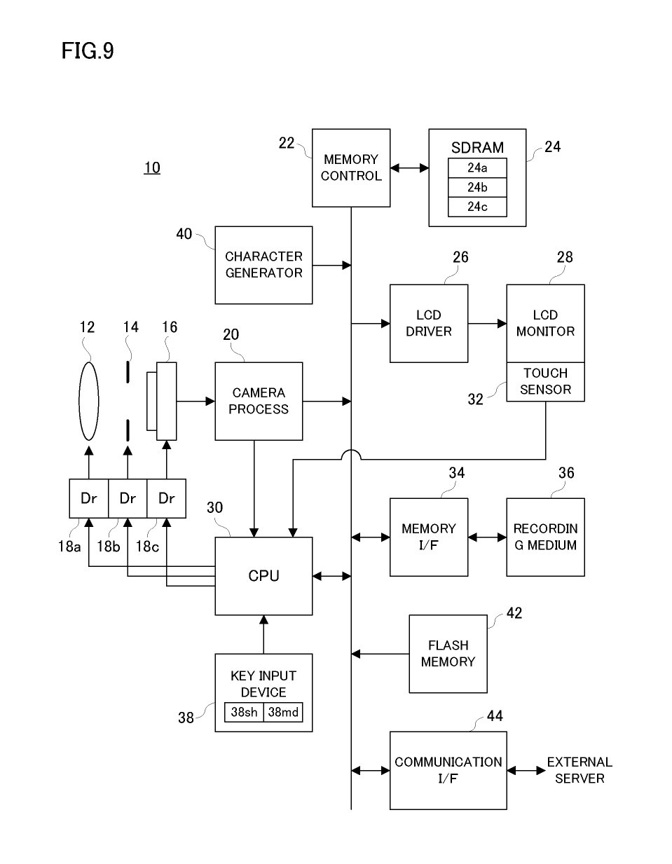

It is noted that, in this embodiment, the control programs equivalent to the multi task operating system and a plurality of tasks executed thereby are previously stored in the flash memory 42. However, a communication I/F 44 may be arranged in the digital camera 10 as shown in FIG. 9 so as to initially prepare a part of the control programs in the flash memory 42 as an internal control program whereas acquire another part of the control programs from an external server as an external control program. In this case, the above-described procedures are realized in cooperation with the internal control program and the external control program.

Furthermore, in this embodiment, the processes executed by the main CPU 30 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A user interface apparatus comprising:
a first displayer which displays any one of a plurality of images on a monitor screen;
a first updater which updates an image to be displayed by said first displayer according to a first rule when a first touch operation to said monitor screen is detected;
a second displayer which displays a specific icon on said monitor screen when an updating manner by said first updater satisfies a predetermined condition; and
a second updater which updates the image to be displayed by said first displayer according to a second rule when a second touch operation to the specific icon displayed by said second displayer is detected.

2. A user interface apparatus according to claim 1, wherein the first touch operation has a directionality, said first updater includes an image designator which designates an image different depending on a direction of the first touch operation, and the predetermined condition includes a frequency condition under which the number of updating to a common direction reaches a threshold value.

3. A user interface apparatus according to claim 2, further comprising a setter which sets the number of updating to a reference value at every time the direction of the first touch operation is changed.

4. A user interface apparatus according to claim 3, further comprising a hider which hides the specific icon displayed by said second displayer in association with a process of said setter.

5. A user interface apparatus according to claim 1, wherein said plurality of images are lined up in a predetermined direction, the first rule is equivalent to a rule designating an image existing at a first distance, and the second rule is equivalent to a rule designating an image existing at a second distance larger than the first distance.

6. A user interface apparatus according to claim 1, wherein the first touch operation is equivalent to a flick operation, and the second touch operation is equivalent to a tap operation.

7. An update control program recorded on a non-transitory recording medium in order to control a user interface apparatus, the program causing a processor of the user interface apparatus to perform the steps comprises:
a first displaying step of displaying any one of a plurality of images on a monitor screen;
a first updating step of updating an image to be displayed by said first displaying step according to a first rule when a first touch operation to said monitor screen is detected;
a second displaying step of displaying a specific icon on said monitor screen when an updating manner by said first updating step satisfies a predetermined condition; and
a second updating step of updating the image to be displayed by said first displaying step according to a second rule when a second touch operation to the specific icon displayed by said second displaying step is detected.

8. An update control method executed by a user interface apparatus, comprising:
a first displaying step of displaying any one of a plurality of images on a monitor screen;
a first updating step of updating an image to be displayed by said first displaying step according to a first rule when a first touch operation to said monitor screen is detected;
a second displaying step of displaying a specific icon on said monitor screen when an updating manner by said first updating step satisfies a predetermined condition; and
a second updating step of updating the image to be displayed by said first displaying step according to a second rule when a second touch operation to the specific icon displayed by said second displaying step is detected.
